(19) United States
(12) Patent Application Publication
(10) Pub. No.: US 2011/0166262 A1
(43) Pub. Date: Jul. 7, 2011

(54) PROCESS FOR MAKING COMPATIBILIZED SILICA AND NITRILE POLYMER COMPOSITIONS

(75) Inventors: Lawrence Douglas Harris, Baton Rouge, LA (US); Harold William Young, Baton Rouge, LA (US); Deepak Rasiklal Parikh, Beaumont, TX (US); Daniel Courtney Patton, Jackson, LA (US); Vernon Vincent Vanis, Spring, TX (US)

(73) Assignee: LION COPOLYMER, LLC, Baton Rouge, LA (US)

(21) Appl. No.: 12/984,267

(22) Filed: Jan. 4, 2011

Related U.S. Application Data
(60) Provisional application No. 61/292,910, filed on Jan. 7, 2010.

(51) Int. Cl. C08L 9/04; C08K 11/00; C08K 5/04; C08K 3/34; C08K 3/04; C08K 3/26; C08K 5/13; C08K 3/32; C08K 5/17; C08K 3/36

(52) U.S. Cl. 524/15; 524/566; 524/35; 524/451; 524/65; 524/426; 524/323; 524/414; 524/343; 524/186; 524/521; 524/493; 524/445

(57) ABSTRACT

A process for forming a compatibilized silica and nitrile polymer blend in latex form is described herein. The process can include treating a silica with a coupling agent in aqueous suspension to form a compatibilized silica slurry. The coupling agent can have the capacity of chemically reacting with the surface of the silica to bond the coupling agent thereto. The process can include blending at least a portion of the compatibilized silica slurry into a styrene butadiene polymer latex, forming a silica styrene butadiene polymer latex, and blending at least a portion of the compatibilized silica slurry into an acrylonitrile butadiene polymer latex, forming a silica acrylonitrile butadiene polymer latex. The process can include blending the silica styrene butadiene polymer latex with the silica acrylonitrile butadiene polymer latex, forming the compatibilized silica and nitrile polymer blend.

### CROSS REFERENCE TO RELATED APPLICATIONS

The present application claims priority to and the benefit of U.S. Provisional Patent Application Ser. No. 61/292,910 filed on Jan. 7, 2010, entitled “PROCESS FOR MAKING COMPATIBILIZED SILICA AND NITRILE POLYMER COMPOSITIONS”. This reference is hereby incorporated in its entirety.

### FIELD

The present embodiments generally relate to a process for forming a compatibilized silica and nitrile polymer blend in latex form, a process for forming an acrylonitrile styrene butadiene terpolymer latex blend with compatibilized silica, a process for forming a blend of acrylonitrile butadiene polymer and styrene butadiene polymer latex blend with compatibilized silica, and a process for forming a compatibilized silica and nitrile polymer blend in latex form.

### BACKGROUND

A need exists to provide a simple and less expensive technique for the uniform incorporation of silica, alone or with other reinforcing agents, such as carbon blacks, into natural and synthetic polymers that does not require the use of complex processing aids.

A need exists for the incorporation of silica, alone or with carbon blacks, into natural and synthetic polymers at the latex stage, that is simple, inexpensive, and can be used to incorporate the silica without causing premature coagulation of the latex.

A need exists for providing a process for the incorporation of a silica reinforcing agent, alone or with other fillers, such as carbon blacks, into natural and synthetic polymers, in which the silica can be substantially uniformly dispersed and compatible with the polymer matrix during processing.

A further need exists for a wet process for treating precipitated or fumed silica with a coupling agent, whereby the silica becomes compatible with a polymer phase of a polymer latex.

The present embodiments meet these needs.

### BRIEF DESCRIPTION OF THE DRAWINGS

The detailed description will be better understood in conjunction with the accompanying drawing as follows:

FIG. 1 is a diagram of an embodiment of a process.

FIG. 2 is a diagram of an embodiment of a process for forming a blend of acrylonitrile and styrene butadiene terpolymer latex with compatibilized silica.

FIG. 3 is a diagram of an embodiment of a process for forming a blend of acrylonitrile butadiene polymer and styrene butadiene polymer latex blend with compatibilized silica.

FIG. 4 is a diagram of an embodiment of a process for forming a compatibilized silica in a latex blend of acrylonitrile butadiene polymer and styrene butadiene polymer.

FIG. 5 is a diagram of an embodiment of a process for forming a compatibilized silica and nitrile polymer blend in latex form.

The present embodiment is detailed below with reference to the listed Figures.

### DETAILED DESCRIPTION OF THE EMBODIMENTS

Before explaining the present processes in detail, it is to be understood that the processes are not limited to the particular embodiments and that the processes can be practiced or carried out in various ways.

The present embodiments relate to a process for forming a polymer blend with a compatibilized silica.

In a first embodiment, the process can include treating a silica to form a compatibilized silica slurry, and then creating a silica styrene butadiene polymer latex with silica acrylonitrile butadiene polymer.

In the first embodiment, a compatibilized silica and nitrile polymer blend in latex form can be created. The formed compatibilized silica and nitrile polymer blend can have a Mooney viscosity (ML 1+4 at 100 C) from 10 to 100, and an acrylonitrile composition from ten to fifty percent by weight.

The first embodiment can include a process that can be carried out while the polymers are in a latex form.

The process can be configured for application to natural rubber latexes and polymerized latexes.

The process can use emulsion polymerization, that is, the polymers can be polymerized into a latex in a reaction mixture prior to a coagulation stage. The terms “latex” or “latex form”, as used herein, refer to an aqueous colloid/emulsion of rubber particles.

The various embodiments described herein can all be performed with polymer latexes, to which other components can be added, such as fillers, antioxidants, UV stabilizers, and carbon black. These processes can form silica-carbon black compositions with uniform high loads of total filler and quantitative incorporation of the fillers.

The processes can be applied to other polymers made in latex form including conjugated diene polymers, polymers based on vinyl monomers, and combinations of conjugated dienes with vinyl monomers.

Suitable vinyl monomers usable herein can include: styrene, alpha-methylstyrene, alkyl substituted styrenes, vinyl toluene, divinylbenzene, acrylonitrile, vinylchloride, methacrylonitrile, isobutylene, maleic anhydride, acrylic esters and acids, methylacrylic esters, vinyl ethers, vinyl pyridines, and the like.

For example, the polymers can be natural rubber, styrene-butadiene rubber (SBR), acrylonitrile-butadiene rubber (NBR), acrylonitrile-butadiene-styrene polymer (ABS), polybutadienes, polyvinylchloride (PVC), polystyrene, polyvinylacetate, butadiene-vinyl pyridine polymers, polyisoprenes, polychloroprene, neoprene, styrene-acrylonitrile copolymer (SAN), blends of acrylonitrile-butadiene rubber with polyvinylchloride, and the like.

To form the compatibilized silica and nitrile polymer blend in latex, surfactants can be used, such as soaps. An initiator can be used, such as pinane hydroperoxide. An activator can be used, such as ferrous sulfate. The soap can be obtained from MeadWestvaco, and can be supplemented with a caustic, such as sodium hydroxide. The soap can be added directly to feed stocks of monomers of styrene, butadiene, and acrylonitrile. The butadiene can be liquid 1,3-butadiene.

Emulsion polymerization for all the processes disclosed herein can occur at temperatures ranging from 1 degree Celsius (C) to 30 degrees Celsius. The conversion for the emulsion polymerizations disclosed herein can range from 59 percent to 80 percent.

The term “natural polymer”, as used herein, refers to polymers made from rubber obtained from botanical sources and the like.

The term “synthetic polymer”, as used herein, refers to fossil fuel derived polymers that have rubber properties or elastomeric properties, and the like.

Mixtures of natural and synthetic polymers can be used.

The polymer latexes can be emulsions with a solids content ranging from 5 percent to 75 percent by weight.

The first embodiment of the process can include treating a silica with a coupling agent in aqueous suspension to form a compatibilized silica slurry.

The aqueous suspension can include water, soaps, emulsifiers, surfactants, or thickeners, including but not limited to viscosity modifiers, such as starch or carboxyl methyl cellulose.

The silica can be treated with a coupling agent, such as an organosilicon bound to a surface of the silica, with the organosilicon covering from one percent to twenty five percent by weight per weight of the silica.

Turning now to the Figures, the different processes may be better understood.

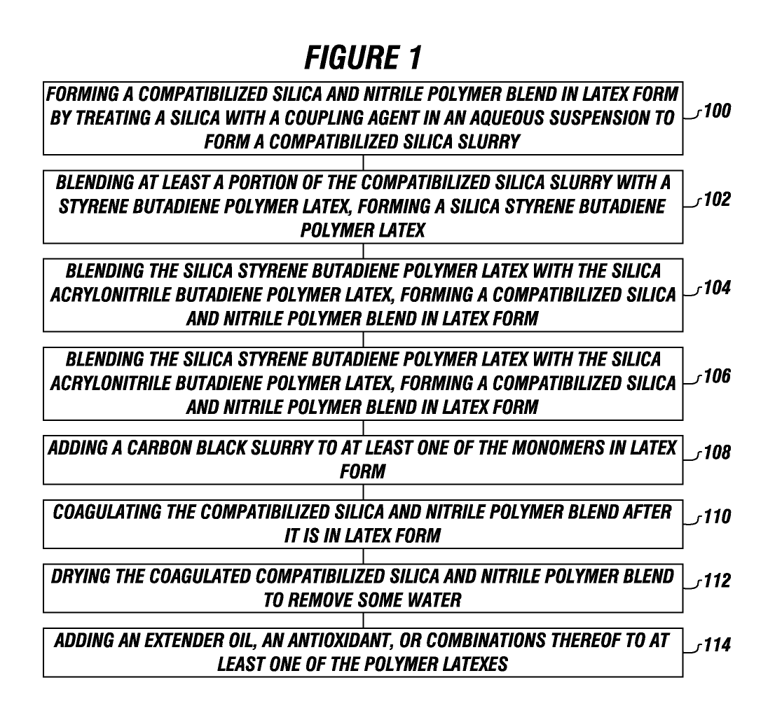

FIG. 1 shows the first embodiment of the process.

Step 100 can include forming a compatibilized silica and nitrile polymer blend in latex form by treating a silica with a coupling agent in an aqueous suspension to form a compatibilized silica slurry.

The coupling agent can be an organosilicon that can chemically react with a surface of silica to form a bond thereto.

Step 102 can include blending at least a portion of the compatibilized silica slurry with a styrene butadiene polymer latex, forming a silica styrene butadiene polymer latex.

Step 104 can include blending at least a portion of the compatibilized silica slurry with an acrylonitrile butadiene polymer latex, forming a silica acrylonitrile butadiene polymer latex.

Step 106 can include blending the silica styrene butadiene polymer latex with the silica acrylonitrile butadiene polymer latex, forming a compatibilized silica and nitrile polymer blend in latex form.

The organosilicon compound can have from one to three readily hydrolyzable groups attached directly to a silicon atom, and at least one organic group attached directly to the silicon atom. The organic group attached directly to the silicon atom can have at least one functional group. The functional group can be a functional group capable of undergoing a chemical reaction with the polymer during curing of the polymer.

The process can use monomers that are homopolymers, fully cross-linked copolymers, partially cross-linked polymer, copolymers, or combinations thereof.

The formed styrene butadiene polymer latex, the silica styrene butadiene polymer latex, and/or the acrylonitrile butadiene polymer latex can additionally comprises a polyisoprene.

The process can use a silica with an average particle size ranging from 0.1 micron to 20 microns.

The process can use as the silica a fumed silica, an amorphous silica, or combinations thereof.

Step 108 can include adding a carbon black slurry to at least one of the monomers in latex form.

The process can use as the coupling agent a component that has the general structure:

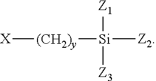

“X” can be a functional group selected from the group consisting of: an amino group, a polyamino alkyl group, a mercapto group, a polysulfide, an epoxy group, a vinyl group, an acryloxy group, and a methacryloxy group. “y” can be an integer equal to or greater than 0. “Z.sub.1”, “Z.sub.2”, and “Z.sub.3” can each be independently selected from the group consisting of: hydrogen, C.sub.1-C.sub.18 alkyl, aryl, cycloalkyl, aryl alkoxy, and halo-substituted alkyl. At least one of “Z.sub.1”, “Z.sub.2”, and “Z.sub.3” can be alkoxy, hydrogen, halogen, or hydroxyl.

The coupling agent can be a bis(trialkoxysilylalkyl)polysulfide containing two to eight sulfur atoms, in which alkyl groups can be C.sub.1-C.sub.18 alkyl groups, and alkoxy groups can be C.sub.1-C.sub.8 alkoxy groups.

Step 110 can include coagulating the compatibilized silica and nitrile polymer blend after it is in latex form.

Step 112 can include drying the coagulated compatibilized silica and nitrile polymer blend to remove some water.

The compatibilized silica slurry can contain from 1 percent to 40 percent by weight silica.

The process can include using an amount of coupling agent that ranges from 1 part to 25 parts by weight of coupling agent per 100 parts by weight of silica.

The process described in FIG. 1 can include using an amount of the compatibilized silica slurry that is within the range of 5 percent to 80 percent by weight based on the weight of the solids in either the silica styrene butadiene polymer latex or the silica acrylonitrile butadiene polymer latex.

Step 114 can include adding an extender oil, an antioxidant, or combinations thereof to at least one of the polymer latexes.

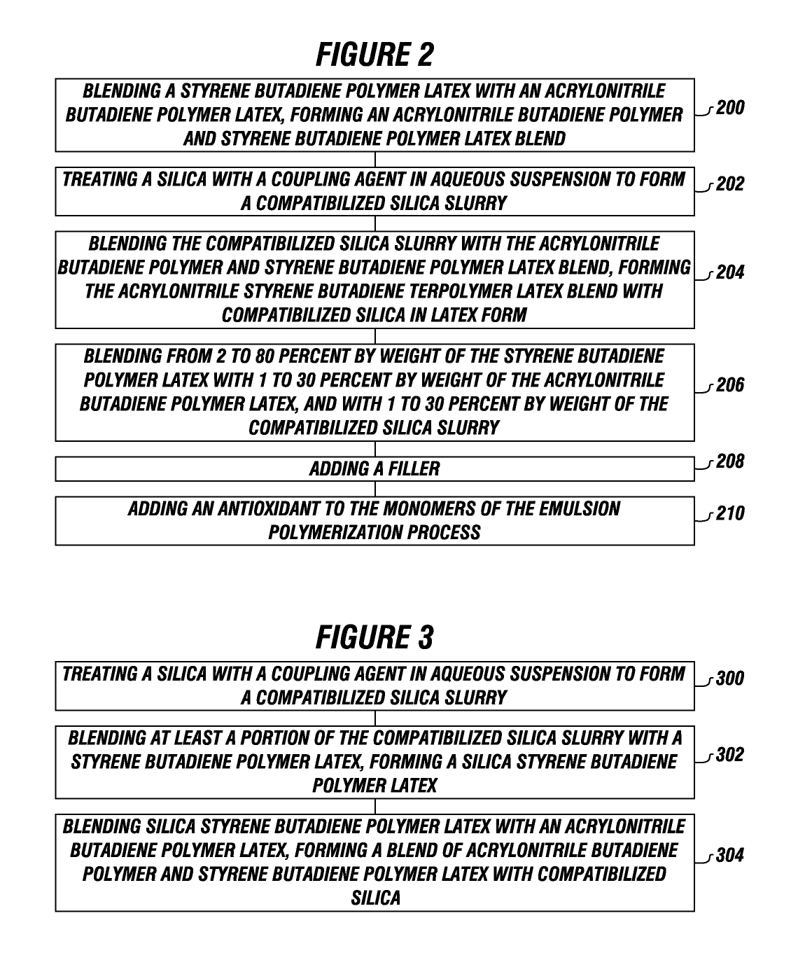

FIG. 2 depicts a process for forming a blend of an acrylonitrile styrene butadiene terpolymer latex blend with compatibilized silica. The process depicted in FIG. 2 can create an acrylonitrile butadiene polymer latex and styrene butadiene polymer latex.

Step 200 can include blending a styrene butadiene polymer latex with an acrylonitrile butadiene polymer latex, forming an acrylonitrile butadiene polymer and styrene butadiene polymer latex blend.

Step 202 can include treating a silica with a coupling agent in aqueous suspension to form a compatibilized silica slurry. The coupling agent can chemically react with a surface of the silica to bond the coupling agent thereto.

Step 204 can include blending the compatibilized silica slurry with the acrylonitrile butadiene polymer and styrene butadiene polymer latex blend, forming the acrylonitrile styrene butadiene terpolymer latex blend with compatibilized silica in latex form.

Step 206 can include blending from 2 percent to 80 percent by weight of the styrene butadiene polymer latex with 1 percent to 30 percent by weight of the acrylonitrile butadiene polymer latex, and with 1 percent to 30 percent by weight of the compatibilized silica slurry. The amount of the compatibilized silica slurry can be within the range of about 5 percent to 80 percent by weight based on the weight of the solids in the latexes.

The process depicted in FIG. 2 can use the same polymers as the process depicted in FIG. 1, and can include adding a carbon black slurry to at least one of the latexes.

The coupling agent usable in the process depicted in FIG. 2 can be an organosilicon compound. The coupling agent can be a bis(trialkoxysilylalkyl)polysulfide containing two to eight sulfur atoms in which the alkyl groups are C.sub.1-C.sub.18 alkyl groups, and the alkoxy groups are C.sub.1-C.sub.8 alkoxy groups. The organosilicon compound can have from one to three readily hydrolyzable groups attached directly to the silicon and at least one organic group attached directly to the silicon atom. The organic group attached directly to the silicon atom can have at least one functional group. The functional group can be a functional group capable of undergoing a chemical reaction with the polymer during curing of the polymer.

The coupling agent can have as the general structure:

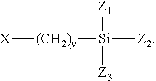

“X” can be a functional group selected from the group consisting of: an amino group, a polyamino alkyl group, a mercapto group, a polysulfide, an epoxy group, a vinyl group, an acryloxy group, and a methacryloxy group. “y” can be an integer equal to or greater than 0. “Z.sub.1”, “Z.sub.2”, and “Z.sub.3” can each be independently selected from the group consisting of: hydrogen, C.sub.1-C.sub.18 alkyl, aryl, cycloalkyl, aryl alkoxy, and halo-substituted alkyl. At least one of “Z.sub.1”, “Z.sub.2”, and “Z.sub.3” can be alkoxy, hydrogen, halogen, or hydroxyl.

The amount of coupling agent used in the process can range from about 1 part to about 25 parts by weight of coupling agent per 100 parts by weight of silica.

The process depicted in FIG. 2 can include using an amount of the compatibilized silica slurry within the range of about 5 percent to 80 percent by weight based on the weight of the solids in either the silica styrene butadiene polymer latex or the silica acrylonitrile butadiene polymer latex.

Step 208 can include adding a filler. The filler can be selected from the group consisting of: diatomaceous earth, ground pecan shells, cellulosic materials, ground peanut shells, talc, ground coal, bagasse, ash, perlite, silage, clay, calcium carbonate, biomass, or combinations thereof.

Step 210 can include adding an antioxidant to the monomers of the emulsion polymerization process. The antioxidant can be a phenolic antioxidant, a phosphite, a bis phenol, an amine antioxidant, or combinations thereof.

FIG. 3 depicts a third embodiment of the process that forms a blend of acrylonitrile butadiene polymer and styrene butadiene polymer latex blend with compatibilized silica prepared by an emulsion polymerization process.

Step 300 can include treating a silica with a coupling agent in aqueous suspension to form a compatibilized silica slurry. Step 300 can be performed in the same manners as described with respect to FIGS. 1 and 2, or any other manner described herein.

Step 302 can include blending at least a portion of the compatibilized silica slurry with a styrene butadiene polymer latex, forming a silica styrene butadiene polymer latex.

Step 304 can include blending silica styrene butadiene polymer latex with an acrylonitrile butadiene polymer latex, forming a blend of acrylonitrile butadiene polymer and styrene butadiene polymer latex with compatibilized silica.

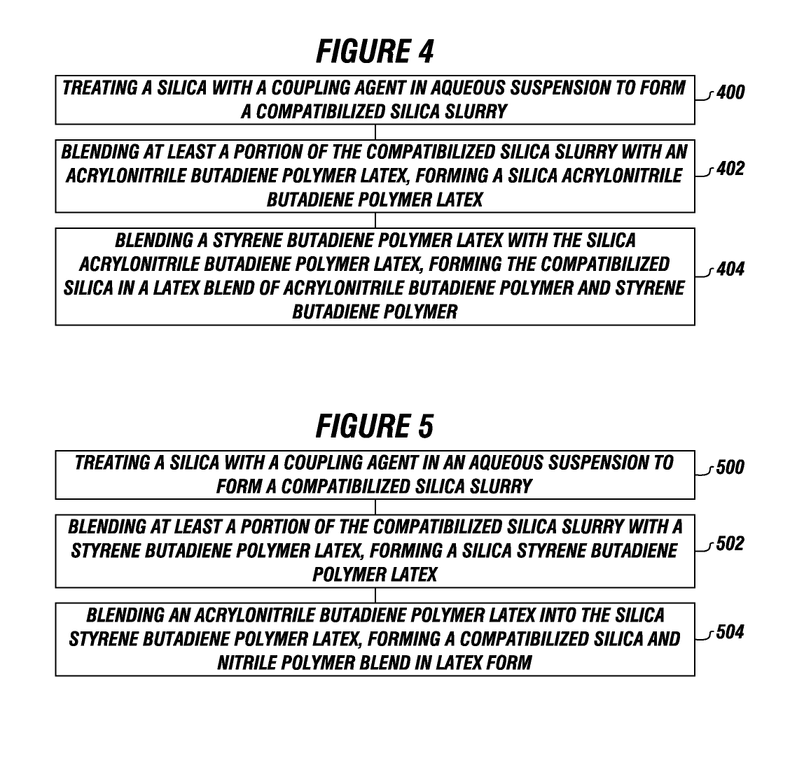

FIG. 4 depicts a fourth embodiment of the process to form a compatibilized silica in a latex blend of acrylonitrile butadiene polymer and styrene butadiene polymer.

Step 400 can include treating a silica with a coupling agent in aqueous suspension to form a compatibilized silica slurry. Step 400 can be performed with any coupling agent described herein, such as those described in FIGS. 1-3.

Step 402 can include blending at least a portion of the compatibilized silica slurry with an acrylonitrile butadiene polymer latex, forming a silica acrylonitrile butadiene polymer latex.

Step 404 can include blending a styrene butadiene polymer latex with the silica acrylonitrile butadiene polymer latex, forming the compatibilized silica in a latex blend of acrylonitrile butadiene polymer and styrene butadiene polymer.

FIG. 5 depicts a fifth embodiment of the process for forming a compatibilized silica and nitrile polymer blend in latex form.

Step 500 can include treating a silica with a coupling agent in an aqueous suspension to form a compatibilized silica slurry. Step 500 can be performed with any coupling agent described herein, such as those described in FIGS. 1-4.

Step 502 can include blending at least a portion of the compatibilized silica slurry with a styrene butadiene polymer latex, forming a silica styrene butadiene polymer latex.

Step 504 can include blending an acrylonitrile butadiene polymer latex into the silica styrene butadiene polymer latex, forming a compatibilized silica and nitrile polymer blend in latex form.

In one or more embodiments, the compatibilized silica slurry can contain from 1 percent to 30 percent by weight silica. For example, the compatibilized silica slurry can contain from about 10 percent to about 15 percent by weight of silica, and up to 20 percent by weight of the coupling agent.

The coupling agent can be a silane or another organosilicon compound. An organosilicon compound is a compound that contains carbon-silicon bonds.

Silica that is not agglomerated can have an average particle size ranging from about 0.1 nanometer to 200 nanometers. In one or more embodiments, a nano-sized silica can be used as the silica, such as polyhedral oligomeric silsesquioxane (POSS). The silica can be a fumed silica, such as a pyrogenic silica, an amorphous silica, such as diatomaceous earth, faujasite, or combinations thereof. The silica can be finely divided silica formed into an aqueous slurry and treated with a solution of the coupling agent.

The coupling agent can be chemically bond to at least 30 percent by weight of the silica surface. The coupling agent can have the capacity to chemically react with the surface of the silica to bond the coupling agent thereto. The coupling agent can bond to the surface of the silica by covalent bonding. The coupling agent can be a variety of compounds known in the prior art for use in coupling hydrophilic filler materials, such as glass fibers, silica, and the like, to hydrophobic materials, such as natural and synthetic polymers useful as rubbers or thermoplastic materials. The amount of coupling agent can range from about 1 part to about 25 parts by weight of coupling agent per 100 parts by weight of silica.

In one or more embodiments, the coupling agent can have a structure the same as or similar to:

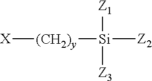

Within the structure, “X” can be or have a functional group selected from the group consisting of: an amino group, a polyamino alkyl group, a mercapto group, a polysulfide, an epoxy group, a vinyl group, an acryloxy group, and a methacryloxy group.

Within the structure, “y” can be an integer equal to or greater than zero.

Within the structure, Z.sub.1, Z.sub.2, and Z.sub.3 can be each independently selected from the group consisting of: hydrogen, C.sub.1-C.sub.18 alkyl, aryl, cycloalkyl, aryl alkoxy, and halo-substituted alkyl. At least one of Z.sub.1, Z.sub.2, or Z.sub.3 can be an alkoxy, a hydrogen, a halogen, or a hydroxyl.

In embodiments of the coupling agent, the organic group can be attached directly to a silicon atom thereof, and can have or include at least one functional group. The functional group can be a functional group capable of undergoing a chemical reaction with the polymer during curing of the polymer.

In embodiments, the process can be applied to a styrene-butadiene rubber to provide a silica composition that can be cured via cross-linking reactions involving sulfur compounds. As such, the coupling agent can be an organosilicon compound with at least one organic group having a mercapto, polysulfide, thiocyanato (—SCN), or a halogen and/or amino functionality. At least one organic group of the organosilicon compound can have ethylene unsaturation or an epoxy group, such that the silica filled polymer can undergo a peroxy type of curing reaction.

In one or more embodiments, one or two alkyl groups can be replaced with a phenyl or benzyl group, or one to two alkyl groups can be replaced with a phenyl, benzyl, or alkoxy substituted alkyl group.

The polymers can be recovered once coagulation has occurred, and once the polymer has been contacted with the compatibilized silica slurry.

During the process, temperature and reaction times can be varied within wide limits during the blending. In embodiments, temperatures can range from ambient temperature to up to about 125 degrees Celsius.

The blending of the latexes can be performed by using a common tank and then blending with a pump impeller, at a rate ranging from 10 rpm to 80 rpm and for a time period ranging from 5 minutes to 1.5 hours.

During the process, an amount of time used for effecting the reaction between the hydrolyzed coupling agent and the silica can be varied within relatively wide limits, which can range from 4 hours to about 48 hours depending on the temperature employed.

During the process, the amount of the silica added to the latex or latexes can be varied within wide ranges depending, in part, on the coupling agent employed, the nature of the polymer latex, the use of other fillers, such as carbon black, and the end use to which the polymer is subjected. For example, the amount of the silica added to the latex or latexes can range from about 1 percent by weight to about 70 percent by weight.

The silica can include chip silica, which is untreated, as well as pretreated silica.

In embodiments, the compatibilized silica slurry can range from about five percent to about sixty percent based on the weight of solids in the polymer latex.

The styrene butadiene polymer latexes can be emulsions that can flow at ambient temperatures, allowing the styrene butadiene polymer latex to be pourable.

A portion of the compatibilized silica slurry and the styrene butadiene polymer latex can be blended by pumping each to a common tank and agitating the mixture at a rate sufficient to keep the emulsion in suspension at operating temperatures. For example, the mixture can be agitated using a pump impeller at a rate ranging from 5 rpm to 80 rpm for 5 minutes to 1.5 hours.

The silica styrene butadiene polymer latex can include a ratio of about 50:50 of the compatibilized silica slurry to the styrene butadiene polymer latex.

The portion of the compatibilized silica slurry and the acrylonitrile butadiene polymer latex can be blended by pumping each to a common tank and agitating the mixture at a rate sufficient to keep the emulsion in suspension at operating temperatures. For example, the mixture can be agitated using a pump impeller at a rate ranging from 5 rpm to 80 rpm for 5 minutes to 1.5 hours.

The formed silica acrylonitrile butadiene polymer latex can include a ratio of about 50:50 of the compatibilized silica slurry to the formed silica acrylonitrile butadiene polymer latex.

In embodiments, the silica styrene butadiene polymer latex with the silica acrylonitrile butadiene polymer latex can be blended by flowing the latexes into a common tank and agitating the mixture. For example, the polymer latexes can be agitated using a impeller of a pump at a rate of 5 rpm to 80 rpm, and for a time period ranging from 5 minutes to 1.5 hours.

One or more embodiments of the process can include adding a carbon black slurry to at least one of the polymer latexes. The carbon black slurry can be or include furnace carbon black which can include high structure carbon black, low structure carbon black, or acetylene carbon black.

The carbon black slurry can be added by flowing the carbon black into one or more of the common tanks described above.

For example, from about 5 percent to about 40 percent by weight of the solids in the carbon black slurry can be added to one or more of the common tanks. The carbon black slurry can be added to the latex in ranges from 1 percent to 80 percent by weight.

From about 0.1 percent to about 60 percent by weight of an extender oil can be added to at least one of the polymer latexes, such as 35 percent by weight. The extender oil can be naphthenic oil, a hydrocarbon based oil, synthetic oil, aromatic oil, low polycyclic aromatic hydrocarbon oil (PAH), or combinations thereof.

An antioxidant can be added to the latex in amounts ranging from about 2 percent to about 0.05 percent by weight. The antioxidant can be added to at least one of the polymer latexes or to combinations thereof. The antioxidant can be a phenolic antioxidant, a phosphite, a bis phenol, an amine antioxidant, or combinations thereof.

Fillers can be added to any one or more of the blend described herein. For example, from about 0.1 percent to about 50 percent by weight of filler can be added to one or more of the blends described herein. The filler can be diatomaceous earth, ground pecan shells, cellulosic materials, ground peanut shells, talc, ground coal, ground bagasse, ash, perlite, silage, clay, calcium carbonate, biomass, or combinations thereof.

Examples describing embodiments of one or more portions of the process are described below.

### Example 1

### Preparation of an SBR-Silica-Carbon Black

A. Preparation of Compatibilized Silica Slurry

An aqueous solution of silane can be prepared by charging to a vessel: 55.1 g of Silquest® A-189 (OSi Specialties), 27 g of isopropanol, 1.1 g of glacial acetic acid, and 27 g of water, which can form an initially cloudy mixture.

The initially cloudy mixture can be agitated at high speed, such as 50 rpm, and at room temperature, such as 72 degrees Fahrenheit, until the mixture is clear.

The high speed agitation can be performed for from about 10 minutes to about 20 minutes, after which, an additional 28 g of water can be added, which can cause the mixture to become cloudy.

Agitation can be continued for from about 15 minutes to about 20 minutes until the mixture is clear again and a solution is formed.

To a separate vessel equipped with a stirrer: 16 lb of water and 4.05 lb of fine-particle, dry silica, HiSil® 233 can be charged and agitated for about fifteen minutes to wet and disperse the silica, forming an aqueous solution of silane.

The aqueous solution of silane can then be added, with continued agitation, with twenty five percent sodium hydroxide, which can be heated to 76 degrees Celsius. As such, the pH can be increased to 7.5-8.0. The temperature can be maintained at 76 degrees Celsius for about 4 hours, and then allowed to cool to about 60 degrees Celsius. At this point the compatibilized silica slurry can be added to the latex stage of a continuous emulsion process, or can be fed batch-wise to a concentrated polymer latex.

B. Blend of Compatibilized Silica Slurry with Styrene Butadiene Rubber Latex

Compatibilized silica slurry can be prepared as described in Part A of Example 1 above.

The compatibilized silica slurry can be charged to an agitated vessel containing a mixture of thirty five pounds of SBR latex containing seven or eight pounds 1502-type rubber and 6 PPD as an antioxidant produced by Sinorgchem and the mixture can be held at 66 degrees Celsius.

Hot carbon black slurry can be charged to the initial mixture. For example, about twenty pounds of the hot carbon black slurry containing about ten percent by weight of N234-type carbon black and about three pounds of hot oil emulsion containing 62.8 percent by weight Sundex® 8125. This mixture can be agitated for thirty minutes at 66 degrees Celsius and at ambient pressure.

The above latex blend can be blended slowly, such as at a rate of 50 rpm, added to a larger agitating vessel containing from about 45 pounds to about 50 pounds of water and sufficient sulfuric acid to give produce a pH of 4.

The rates of addition of the latex blend and the sulfuric acid can be varied to maintain the pH of the resulting coagulation serum in the range of 4-5 pH over the 38 minute time period that the latex blend is added.

An additional thirty eight minutes of mix time and an additional portion of the acid can be used as needed to allow the product particle size to grow to a size of a crumb such as 1 millimeter to 30 millimeters, and to clear the serum of free latex, as is commonly done by those familiar with the art.

The wet composition particle or crumb size achieved by this coagulation can be similar to that obtained from coagulations without silica.

Visual inspection and chemical analysis of the dried composition can verify that essentially all solid and liquid components added to the latex mixture are absorbed and uniformly distributed. Silica absorption can be about 96 percent to 99 percent of charge as estimated by ash analysis.

### Example 2

### Preparation of an Styrene Butadiene Rubber-Silica-Carbon Black Composition

A. Preparation of Compatibilized Silica Slurry

An aqueous solution of silane can be prepared by charging to a vessel: 100 g of Silquest® A-189, 50 g of isopropanol, 2 g of glacial acetic acid, and 47 g of water, forming a cloudy mixture. The initially cloudy mixture can be agitated at high speed and room temperature until clear, such as for about 1 minutes to about 22 minutes, after which an additional 50 g of water can be added that can cause the mixture to become cloudy. Agitation can be continued for about 12 minutes to about 22 minutes until the solution is clear.

To a separate vessel equipped with a stirrer: 15 lb of water and 5 lb of fine-particle dry silica HiSil® 233 can be charged and agitated for about 20 minutes, such that the silica becomes wet and dispersed. The aqueous solution of silane can then added with continued agitation to 25 percent sodium hydroxide, with the pH being increased to 7.5-8.0. The blend can be heated to about 64 degrees Celsius to about 77 degrees Celsius. The temperature can be maintained at about 64 degrees Celsius to about 77 degrees Celsius for about 3.5 hours, and then allowed to cool to 60 degrees Celsius. At this point the compatibilized silica slurry can be added to the latex stage of a continuous emulsion process or can be fed batch-wise to a concentrated polymer latex.

B. Blend of Compatibilized Silica Slurry with Styrene Butadiene Rubber (SBR) Latex

The compatibilized silica slurry, prepared as described in Part A of Example 2 above, can be charged to an agitating vessel containing a latex mixture as described in Example 1. The final composition mixture can be agitated for 35 minutes at 60 degrees Celsius.

The above latex blend can be coagulated, as described in Example 1. The wet composition particle or crumb size achieved by this coagulation can be similar to or slightly larger than that obtained from coagulations without silica, such as a size of 1 millimeter to 30 millimeters. Visual inspection and chemical analysis of the dried composition can verify that essentially all solid and liquid components added to the latex mixture are absorbed and uniformly distributed. Silica absorption can be about 96 percent to about 99 percent of charge as estimated by ash analysis.

### Example 3

### Preparation of an SBR-Silica Composition

Compatibilized Silica Slurry, prepared as described in Part A of Example 2 above, can be charged to an agitated vessel containing a latex mixture prepared from 40 lb of SBR latex containing 20 percent by weight of the 1502 SBR and 2 percent by weight Santoflex 134, which can be held at 60 degrees Celsius.

To this mixture 3 lbs of hot oil emulsion containing 60 percent by weight of Sundex 8125 can be charged. The mixture can then be agitated for an additional 38 minutes while maintaining a temperature of 60 degrees Celsius, after which the hot latex can be slowly charged to another vessel for coagulation.

The dewatered crumb can be similar in particle size to that of SBR without silica, such as 1 millimeter to 30 millimeters, it masses together. Visual inspection and chemical analysis of the dry crumb can show that essentially all of the oil and silica added to the latex are absorbed and uniformly distributed. Silica absorption can be 96 percent to 99 percent of the charge as estimated by ash analysis.

### Example 4

### Preparation of an Nitrile Butadiene Rubber (NBR)-Silica Composition

A. Preparation of Compatibilized Silica Slurry

An aqueous solution of silane can be prepared by charging to a vessel: 20 g of Silquest® A-189, 15 g of isopropanol, 0.7 g of glacial acetic acid, and 10 g of water, forming an initially cloudy mixture. The initially cloudy mixture can be agitated at high speed and room temperature until clear, such as for about 10 minutes to 20 minutes, after which an additional 15 g of water can be added, which can cause the mixture to become cloudy. Agitation can be continued for about 12 minutes to 25 minutes until the solution is clear.

To a separate vessel equipped with a stirrer: 7 lb of water and 2 lb of fine-particle dry silica, HiSil® 233, can be charged and agitated for about 20 minutes, such that the silica becomes wet and dispersed. The aqueous solution of silane can then added with continued agitation with 25 percent sodium hydroxide, such that the pH is increased to 7.5-8.0. The blend can be heated to 70 degrees Celsius, and maintained there for about 3.5 hours, after which it can be allowed to cool to 60 degree Celsius. At this point the compatibilized silica slurry can be added to the latex stage of a continuous emulsion process or fed batch-wise to a concentrated polymer latex.

B. Blend Compatibilized Silica Slurry with NBR Latex

Compatibilized silica slurry, prepared accorded to Part A of Example 4, can be charged to an agitated vessel containing a mixture of: 30 lbs of acrylonitrile butadiene polymer (NBR) latex containing 22 percent by weight Nysyn® 40-5 rubber and 200 grams of antioxidant emulsion containing 16 percent by weight Agerite Geltrol™ (Vanderbilt Chemical), which can be held at 60 degrees Celsius. To this initial mixture, 15 lb of hot carbon black slurry containing 7 percent by weight N234-type carbon black can be charged. The final mixture can be agitated for 35 minutes at 60 degrees Celsius.

The above latex blend can be slowly added to a larger vessel containing 30 lbs of water and sufficient sulfuric acid to give a pH of 4. The coagulation can be completed as described in previous examples. The wet composition crumb size achieved by this coagulation can be similar to that obtained from NBR coagulations without silica, such as 1 millimeter to 30 millimeters. Visual inspection and chemical analysis of the dried composition can show that essentially all solid and liquid components added to the latex mixture are absorbed and uniformly distributed. Silica absorption can be 96 percent to 99 percent by weight of charge as estimated by ash analysis.

The processes described herein can include coagulating the polymer at temperatures between 57 degrees Celsius and 74 degrees Celsius.

The processes described herein can include filtering the coagulated polymer to remove excess water, such as by using a screen, cellulose membrane filter, French oil mill, or by squeezing out water from the polymer.

The processes described herein can include drying the separated polymer using heat, such as by using heat in a dryer oven, trays with heat in a dryer oven, or a fluidized bed.

The processes described herein can be continuous emulsion polymerization or batch processes.

While these embodiments have been described with emphasis on the embodiments, it should be understood that within the scope of the appended claims, the embodiments might be practiced other than as specifically described herein.

What is claimed is:

1. A process for forming a compatibilized silica and nitrile polymer blend in latex form, the process comprising:
a. treating a silica with a coupling agent in an aqueous suspension to form a compatibilized silica slurry, wherein the coupling agent chemically reacts with a surface of the silica to bond the coupling agent thereto;
b. blending at least a portion of the compatibilized silica slurry with a styrene butadiene polymer latex, forming a silica styrene butadiene polymer latex;
c. blending at least a portion of the compatibilized silica slurry with an acrylonitrile butadiene polymer latex, forming a silica acrylonitrile butadiene polymer latex; and
d. blending the silica styrene butadiene polymer latex with the silica acrylonitrile butadiene polymer latex, forming a compatibilized silica and nitrile polymer blend in latex form.

2. The process of claim 1, wherein the coupling agent is an organosilicon compound.

3. The process of claim 2, wherein the organosilicon compound has from one to three readily hydrolyzable groups attached directly to a silicon atom and at least one organic group attached directly to the silicon atom, wherein the at least one organic group has at least one functional group, and wherein the at least one functional group is a functional group capable of undergoing a chemical reaction with the styrene butadiene polymer latex, the acrylonitrile butadiene polymer latex, or combinations thereof during curing.

4. The process of claim 1, wherein at least one of the polymer latexes is a copolymer, a homopolymer, a cross-linked polymer, a partially cross-linked polymer, or combinations thereof.

5. The process of claim 1, wherein either the styrene butadiene polymer latex, the silica styrene butadiene polymer latex, or the acrylonitrile butadiene polymer latex comprises a polyisoprene.

6. The process of claim 1, wherein the silica has an average particle size ranging from 0.1 micron to 20 microns.

7. The process of claim 1, wherein the silica is a fumed silica, an amorphous silica, or combinations thereof.

8. The process of claim 1, further comprising adding a carbon black slurry to at least one of the polymer latexes.

9. The process of claim 1, wherein the coupling agent has the general structure: 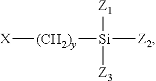
wherein X is a functional group selected from the group consisting of: an amino group, a polyamino alkyl group, a mercapto group, a polysulfide, an epoxy group, a vinyl group, an acryloxy group, and a methacryloxy group, wherein y is an integer equal to or greater than 0, wherein Z.sub.1, Z.sub.2, and Z.sub.3 are each independently selected from the group consisting of: hydrogen, C.sub.1-C.sub.18 alkyl, aryl, cycloalkyl, aryl alkoxy, and halo-substituted alkyl, and wherein at least one of Z.sub.1, Z.sub.2, or Z.sub.3 is an alkoxy, a hydrogen, a halogen, or a hydroxyl.

10. The process of claim 1, wherein the coupling agent is a bis(trialkoxysilylalkyl)polysulfide containing two to eight sulfur atoms with alkyl groups that are C.sub.1-C.sub.18 alkyl groups and alkoxy groups that are C.sub.1-C.sub.8 alkoxy groups.

11. The process of claim 1, further comprising coagulating the compatibilized silica and nitrile polymer blend in latex form.

12. The process of claim 11, further comprising drying the coagulated compatibilized silica and nitrile polymer blend in latex form to remove water.

13. The process of claim 11, wherein the compatibilized silica slurry contains from one percent to forty percent by weight of the silica.

14. The process of claim 13, wherein the amount of the coupling agent ranges from one part by weight to twenty five parts by weight of the coupling agent per one hundred parts by weight of the silica.

15. The process of claim 13, wherein the amount of the compatibilized silica slurry is within a range of five percent by weight to eighty percent by weight based on a weight of the solids in either the silica styrene butadiene polymer latex or the silica acrylonitrile butadiene polymer latex.

16. The process of claim 1, further comprising adding an extender oil, an antioxidant, or combinations thereof to at least one of the polymer latexes.

17. A process for forming a blend of an acrylonitrile styrene butadiene terpolymer latex blend with compatibilized silica, the process comprising:
a. blending a styrene butadiene polymer latex with an acrylonitrile butadiene polymer latex, forming an acrylonitrile butadiene polymer and styrene butadiene polymer latex blend;
b. treating a silica with a coupling agent in aqueous suspension to form a compatibilized silica slurry, wherein the coupling agent chemically reacts with a surface of the silica to bond the coupling agent thereto; and
c. blending the compatibilized silica slurry with the acrylonitrile butadiene polymer and styrene butadiene polymer latex blend, forming the acrylonitrile styrene butadiene terpolymer latex blend with compatibilized silica in latex form.

18. The process of claim 17, wherein forming the acrylonitrile butadiene polymer latex and styrene butadiene polymer latex comprises blending:
a. from two percent by weight to eighty percent by weight of the styrene butadiene polymer latex;
b. from one percent by weight to thirty percent by weight of the acrylonitrile butadiene polymer latex; and
c. from one percent by weight to thirty percent by weight of the compatibilized silica slurry, wherein an amount of the compatibilized silica slurry is within the range of five percent by weight to eighty percent by weight based on a weight of solids in the styrene butadiene polymer latex and the acrylonitrile butadiene polymer latex.

19. The process of claim 17, wherein at least one of the polymer latexes is a copolymer, a homopolymer, a cross-linked polymer, a partially cross-linked polymer, or combinations thereof.

20. The process of claim 17, further comprising adding a carbon black slurry to at least one of the polymer latexes.

21. The process of claim 17, wherein the coupling agent is an organosilicon compound.

22. The process of claim 21, wherein the organosilicon compound has from one to three readily hydrolyzable groups attached directly to a silicon atom and at least one organic group attached directly to the silicon atom, wherein the at least one organic group has at least one functional group, and wherein the at least one functional group is a functional group capable of undergoing a chemical reaction with the polymer latexes during curing.

23. The process of claim 17, wherein the coupling agent has the general structure: 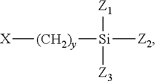
wherein X is a functional group selected from the group consisting of: an amino group, a polyamino alkyl group, a mercapto group, a polysulfide, an epoxy group, a vinyl group, an acryloxy group, and a methacryloxy group, wherein y is an integer equal to or greater than 0, wherein Z.sub.1, Z.sub.2, and Z.sub.3 are each independently selected from the group consisting of: hydrogen, C.sub.1-C.sub.18 alkyl, aryl, cycloalkyl, aryl alkoxy, and halo-substituted alkyl, and wherein at least one of Z.sub.1, Z.sub.2, or Z.sub.3 is an alkoxy, a hydrogen, a halogen, or a hydroxyl. The process of claim 17, wherein the coupling agent is a bis(trialkoxysilylalkyl)polysulfide containing two to eight sulfur atoms in which the alkyl groups are C.sub.1-C.sub.18 alkyl groups and the alkoxy groups are C.sub.1-C.sub.8 alkoxy groups.

24. The process of claim 17, wherein an amount of the coupling agent ranges from one part by weight to twenty five parts by weight of the coupling agent per one hundred parts by weight of the silica.

25. The process of claim 17, wherein an amount of the compatibilized silica slurry is within a range of five percent by weight to eighty percent by weight based on a weight of solids in either the silica styrene butadiene polymer latex or the silica acrylonitrile butadiene polymer latex.

26. The process of claim 17, further comprising adding a filler from the group consisting of: diatomaceous earth, ground pecan shells, cellulosic materials, ground peanut shells, talc, ground coal, bagasse, ash, perlite, silage, clay, calcium carbonate, biomass, and combinations thereof.

27. The process of claim 17, further comprising adding an antioxidant, wherein the antioxidant is a phenolic antioxidant, a phosphite, a bis phenol, an amine antioxidant, or combinations thereof.

28. A method for forming an acrylonitrile butadiene polymer and styrene butadiene polymer latex blend with compatibilized silica, the method comprising:
a. treating a silica with a coupling agent in aqueous suspension to form a compatibilized silica slurry, wherein the coupling agent chemically reacts with a surface of the silica to bond the coupling agent thereto;
b. blending at least a portion of the compatibilized silica slurry with a styrene butadiene polymer latex, forming a silica styrene butadiene polymer latex; and
c. blending the silica styrene butadiene polymer latex with an acrylonitrile butadiene polymer latex, forming a blend of acrylonitrile butadiene polymer and styrene butadiene polymer latex with compatibilized silica.

29. A compatibilized silica in a latex blend of acrylonitrile butadiene polymer and styrene butadiene polymer prepared by a process comprising:
a. treating a silica with a coupling agent in aqueous suspension to form a compatibilized silica slurry, wherein the coupling agent chemically reacts with a surface of the silica to bond the coupling agent thereto;
b. blending at least a portion of the compatibilized silica slurry with an acrylonitrile butadiene polymer latex, to form a silica acrylonitrile butadiene polymer latex; and
c. blending a styrene butadiene polymer latex with the silica acrylonitrile butadiene polymer latex, forming the compatibilized silica in a latex blend of acrylonitrile butadiene polymer and styrene butadiene polymer.

30. A process for forming a compatibilized silica and nitrile polymer blend in latex form, the process comprising:
a. treating a silica with a coupling agent in an aqueous suspension to form a compatibilized silica slurry, wherein the coupling agent chemically reacts with a surface of the silica to bond the coupling agent thereto;
b. blending at least a portion of the compatibilized silica slurry with a styrene butadiene polymer latex, forming a silica styrene butadiene polymer latex; and
c. blending an acrylonitrile butadiene polymer latex into the silica styrene butadiene polymer latex, forming the compatibilized silica and nitrile polymer blend in latex form.
